(19) United States
(12) Patent Application Publication
(10) Pub. No.: US 2005/0198555 A1
(43) Pub. Date: Sep. 8, 2005

(54) Incorporating instruction reissue in an instruction sampling mechanism

(76) Inventors: Mario I. Wolczko, San Carlos, CA (US); Adam R. Talcott, San Jose, CA (US)

Correspondence Address: HAMILTON & TERRILE, LLP, P.O. BOX 203518, AUSTIN, TX, 78720, US

(21) Appl. No.: 10/792,441

(22) Filed: Mar. 3, 2004

(51) Int. Cl. G06F 7/38

(52) U.S. Cl. 714/45; 712/227

(57) ABSTRACT

A method of sampling instructions executing in a processor which includes selecting an instruction for sampling, gathering sampling information for the instruction, determining whether the instruction reissues during execution of the instruction, and storing reissue sample information if the instruction reissues during execution of the instruction. The method also includes storing certain sampling information as resettable sampling information and certain sampling information as persistent sampling information.

### BACKGROUND OF THE INVENTION

1. Field of the Invention

The present invention relates to processors, and more particularly to sampling mechanisms of processors.

2. Description of the Related Art

One method of understanding the behavior of a program executing on a processor is for a processor to randomly sample instructions as the instructions flow through the instruction pipeline. For each sample, the processor gathers information about the execution history (i.e., sampling information) and provides this sampling information to a software performance monitoring tool. Unlike tools which aggregate information over many instructions (e.g., performance counters), such an instruction sampling mechanism allows the performance analyst to map processor behaviors back to a specific instruction. Instruction sampling can be particularly challenging in superscalar processors, particularly in superscalar processors which execute instructions out of order.

It would be desirable to provide a sampling mechanism with the ability to determine whether an instruction replayed or reissued before completing execution. An instruction is replayed (i.e., reissued) if the instruction was dispatched to a functional unit, did not complete execution and was redispatched to a functional unit to complete execution. One example of an instruction that is reissued is a load instruction that is issued speculatively assuming that the load instruction will hit in a data cache of the processor. If the load instruction misses in the data cache (i.e., the data that the instruction is trying to load is not present in the data cache), then the load instruction and all instructions dependent upon that load instruction which previously issued will have to issue again (i.e., be reissued) once the load data can be obtained from the data cache.

With instruction based sampling, information relating to whether an instruction reissued before completing execution may be challenging to either obtain or maintain. More specifically, because sampling information is generally maintained for the most recent execution of the instruction, this sampling information would not include information relating to earlier executions of the same instruction. (In most cases, this earlier sampling information is overwritten during a more recent execution of the instruction.) Simply collecting the events for each instruction issue in the sample instruction history may lead to inaccurate histories or a confusing sample history in which several mutually exclusive or contradictory events are asserted. Furthermore, while doing performance analysis with instruction samples, it can be useful to know when an instruction issues multiple times in order to quantify the performance impact of such replays.

### SUMMARY OF THE INVENTION

The present invention allows software using a sampling mechanism to determine when a sampled instruction has been reissued. Determining when a sampled instruction has been reissued allows interpretation of the sample to take this information into account. The information gathered for an instruction sample includes a bit to indicate when a sampled instruction has been reissued.

Additionally, the present invention enables certain sample information to be persistent or “sticky” relative to the sample (i.e., once the information is set, the information remains set until the sample is reported or discarded, even if the instruction issues again and that event which caused the information to be set does not subsequently occur). For example, sample events which record on which execution pipeline the instruction issued may be maintained as persistent sampling information while the information for the sampled instruction is gathered. At least one of these events is set if the instruction reissues, depending on whether or not the instruction is always issued to the same pipeline. Other events record only the information associated with the last execution of an instruction. For example, a taken branch may resolve not taken based upon speculative data, reissue and finally resolve as taken. A sampling event which records the outcome of the branch should be reset so that the sample information will reflect the actual branch outcome. In the sampling mechanism of the present invention, there are two types of sampling events. Persistent sampling events which, once set, remain set even if the instruction reissues and the event does not occur, and resettable sampling events which store only information about the most recent instruction execution and are therefore reset whenever the instruction issues.

In one embodiment, the invention relates to a method of sampling instructions executing in a processor which includes selecting an instruction for sampling, gathering sampling information for the instruction, determining whether the instruction reissues during execution of the instruction, and storing reissue sample information if the instruction reissues during execution of the instruction.

In another embodiment, the invention relates to an apparatus for sampling instructions executing in a processor which includes means for selecting an instruction for sampling, means for gathering sampling information for the instruction, means for determining whether the instruction reissues during execution of the instruction, and means for storing reissue sample information if the instruction reissues during execution of the instruction.

In another embodiment, the invention relates to a sampling mechanism for sampling an instruction which includes sampling logic and an instruction history register logic coupled to the sampling logic. The sampling logic selects an instruction for sampling. The instruction history register logic stores reissue sample information if the instruction reissues during execution of the instruction.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a processor having a sampling mechanism in accordance with the present invention.

FIGS. 2A and 2B show a flow chart of the operation of the sampling mechanism in accordance with the present invention.

### DETAILED DESCRIPTION

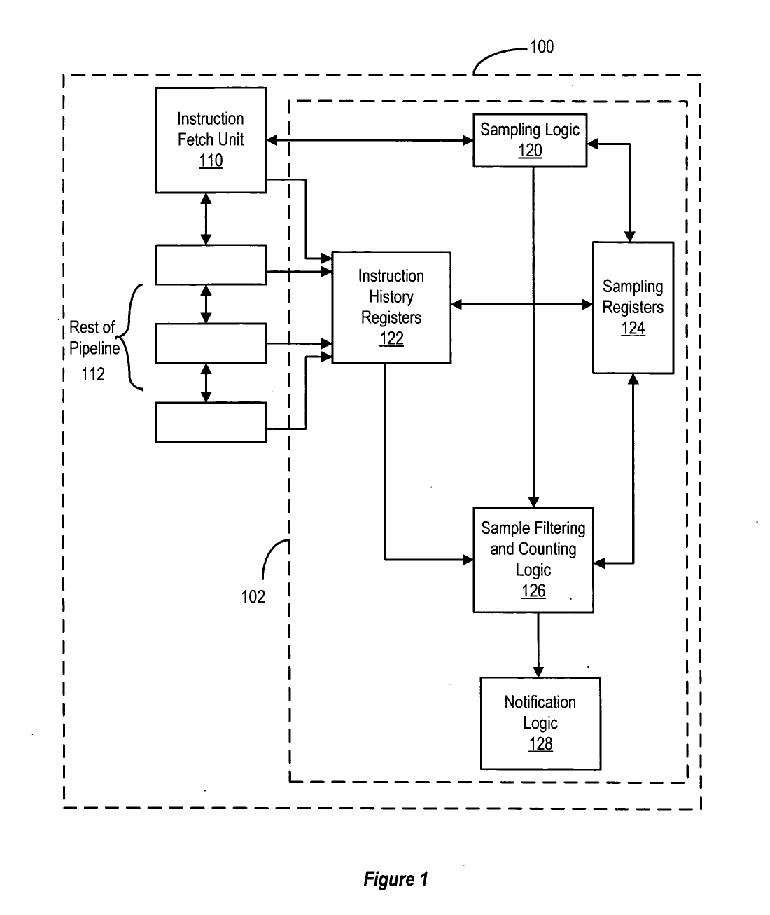

Referring to FIG. 1, processor 100 includes sampling mechanism 102. This sampling mechanism 102 is provided to collect detailed information about individual instruction executions including whether an individual instruction reissues during execution. The sampling mechanism 102 is coupled to the instruction fetch unit 110 of the processor 100. The fetch unit 110 is also coupled to the remainder of the processor pipeline 112. Processor 100 includes additional processor elements as is well known in the art.

In the processor 100, certain instructions may be executed using speculative data. For example, processor 100 may issue an instruction dependent on a load instruction assuming that the load instruction hits in the data cache. If the load instruction does not hit on the data cache, then the instruction dependent on the load instruction would need to reissue.

The sampling mechanism 102 includes sampling logic 120, instruction history registers 122, sampling registers 124, sample filtering and counting logic 126 and notification logic 128. The sampling logic 120 is coupled to the instruction fetch unit 110, the sampling registers 124 and the sample filtering and counting logic 126. The instruction history registers 122 receive inputs from the instruction fetch unit 110 as well as the remainder of the processor pipeline 112; the instruction history registers 122 are coupled to the sampling registers 124 and the sample filtering and counting logic 126. The sampling registers 124 are also coupled to the sample filtering and counting logic 126. The sample filtering and counting logic 126 are coupled to the notification logic 128.

The sampling mechanism 102 collects detailed information about individual instruction executions. If a sampled instruction meets certain criteria, the instruction becomes a reporting candidate. When the sampling mode is enabled, instructions are selected randomly by the processor 100 (via, e.g., a linear feedback shift register) as they are fetched. An instruction history is created for the selected instruction.

The instruction history includes such things as events induced by the sample instruction and various associated latencies. The instruction history includes both persistent sampling information and resettable sampling information. When all events for the sample instruction have occurred (e.g., after the instruction retires or aborts), the information is compared with desired information to determine whether the sampling information includes any events of interest.

The sampling mechanism allows software to determine when a sampled instruction has been reissued. Determining when a sampled instruction has been reissued allows interpretation of the sample to take this information into account. Reissue sample information is stored within the sampling mechanism to indicate when a sampled instruction has been reissued. For example, a reissue bit may be set within the instruction history.

Additionally, the sampling mechanism includes certain sample information which is persistent or “sticky” within the sample (i.e., once the information is set, the information remains set for the remainder of the sampling of the sampled instruction, even if the instruction issues again and that event which caused the information to be set does not subsequently occur). For example, sample events which record on which execution pipeline the instruction issued may be maintained as persistent sampling information while the sampling information for the sampled instruction is gathered. At least one of these events is set if the instruction reissues, depending on whether or not the instruction is always issued to the same pipeline. Other events record only the information associated with the last execution of an instruction. For example, a taken branch may resolve not taken based upon speculative data, reissue and finally resolve as taken. A sampling event which records the outcome of the branch should be reset so that the sample information will reflect the actual branch outcome. In the sampling mechanism of the present invention, there are two types of sampling events. Persistent sampling events which, once set, remain set even if the instruction reissues and the event does not occur, and resettable sampling events which store only information about the most recent instruction execution and are therefore reset whenever the instruction issues.

The sampling mechanism stores information relating to at least two types of sampling events. Persistent sampling events which, once set, remain set even if the instruction reissues and the event does not occur, and resettable sampling events which store only information about the most recent instruction execution and are therefore overwritten whenever the instruction issues.

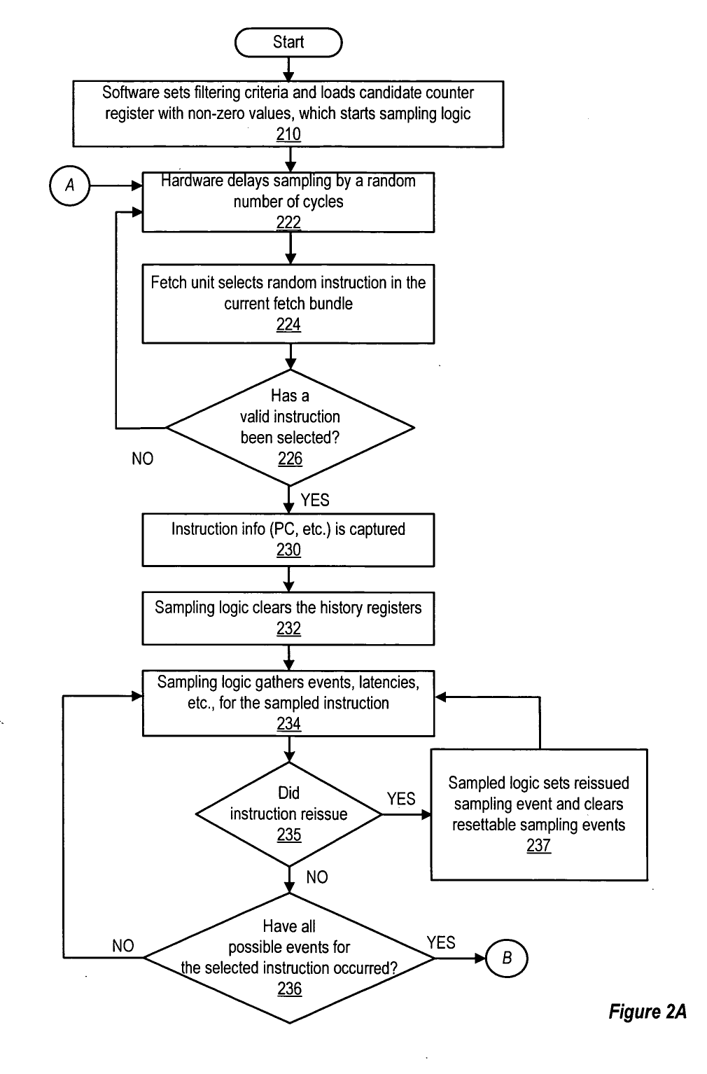

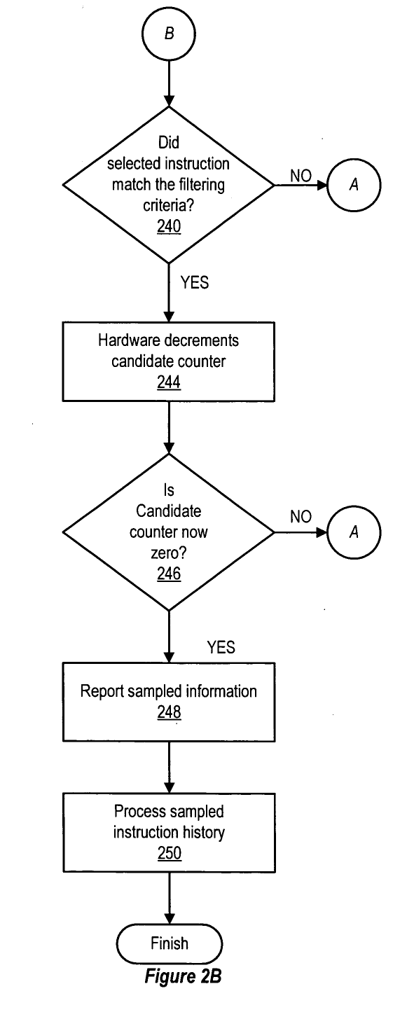

FIGS. 2A and 2B show a flowchart of the operation of sampling mechanism 102. More specifically, at step 210, the software sets filtering criteria and loads a candidate counter register, located within the sample filtering and counting logic 126, with a non-zero value, thus enabling the sampling logic 120. Once the counter register is loaded, the sample filtering and counting logic 126 delays sampling by a random number of cycles at step 222. Next the fetch unit 110 selects a random instruction from a current fetch bundle at step 224. The instruction is analyzed to determine whether a valid instruction has been selected at step 226. If not, then the sampling mechanism 102 returns to step 222.

If the fetched instruction is a valid instruction, then instruction information is captured at step 230. The instruction information includes, for example, the program counter (PC) of the instruction as well as privileged information and context information of the instruction. Next, the sample logic 120 clears the instruction history registers 122 at step 232. Next, during execution of the instruction by the processor 100, the sampling logic 120 gathers events, latencies, etc. for the sampled instruction at step 234. The sampling logic 120 then determines whether the instruction reissues at step 235. If the instruction did not reissue, then the sample logic 120 then reviews the processor state to determine whether all possible events for the selected instruction have occurred at step 236. If not, then the sampling logic 120 continues to gather events etc. at step 234. If the instruction did reissue, as determined by step 235, then the sampling logic sets the reissued sampling event, clears the resettable sampling events and returns to step 234 where the sampling logic again gathers information for the reissued sampled instruction.

If all possible events for the selected instruction have occurred, then the instruction is examined at step 240 to determine whether the selected instruction matches the filtering criteria (i.e., is the selected instruction of interest to the software?). If not, then control returns to step 222 where the counting logic 126 delays the sampling by a random number of cycles to select another instruction for sampling.

If yes, then the counting logic 126 decrements a candidate counter at step 244. Next the candidate counter is analyzed to determine whether the candidate counter is zero at step 246. If the candidate counter is not zero, then control returns to step 222 where the counting logic 126 delays the sampling by a random number of cycles prior to selecting another instruction. If the candidate counter equals zero, then the notification logic 128 reports the sampled instruction at step 248. The candidate counter register value is used to count candidate samples which match the selection criteria. On the transition from 1 to 0 (when made by hardware following a sample) a notification is provided and the instruction history is made available via the SIH registers. The counter then stays at zero until changed by software. The power-on value of the candidate counter register value is 0. The candidate counter allows software to control how often samples are reported, and thus limits the reporting overhead for instructions which are both interesting and frequent. The software then processes the sampled instruction history at step 250 and the processing of the sampling mechanism 102 finishes.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while a particular processor architecture and sampling mechanism architecture is set forth, it will be appreciated that variations within these architectures are within the scope of the present invention.

Also for example, additional instruction history sampling information may be persistently stored. For example, this additional persistent sampling information may include one or more of a data cache replayed condition indication, a memory buffer replayed condition indication or an overeager load condition indication. The data cache replayed condition indication indicates that a load instruction was replayed at least once due to a data cache condition. The memory buffer replayed condition indication indicates that a load or store instruction was replayed due to a condition in a memory buffer, such as a memory disambiguation buffer. The overeager load condition indication indicates that the sample instruction was a store instruction which caused an overeager load to occur. (An overeager load is a younger load instruction that is issued ahead of an older store instruction to the same address.)

Also for example, the above-discussed embodiments include modules that perform certain tasks. The modules discussed herein may include hardware modules or software modules. The hardware modules may be implemented within custom circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method of sampling instructions executing in a processor comprising:
selecting an instruction for sampling;
gathering sampling information for the instruction;
determining whether the instruction reissues during execution of the instruction;
storing reissue sample information if the instruction reissues during execution of the instruction.

2. The method of claim 1 wherein
the reissue sample information is persistent sample information.

3. The method of claim 1 wherein
the sample information includes resettable sample information; and,
the resettable sample information is reset whenever the instruction reissues.

4. The method of claim 1 wherein
the sampling information is stored within an instruction history for the instruction; and
the instruction history includes a reissue bit, the reissue bit indicating whether the instruction reissued.

5. The method of claim 1 wherein
the sampling information includes a data cache replayed condition indication, the data cache replayed condition indicating that a load instruction was replayed at least once due to a data cache condition, the data cache replayed condition indication being persistent sample information.

6. The method of claim 1 wherein
the sampling information includes a memory buffer replayed condition indication, the memory buffer replayed condition indication indicating that a load or store instruction was replayed due to a condition in a memory buffer data cache replayed condition indication, the memory buffer replayed condition indication being persistent sample information.

7. The method of claim 1 wherein
the sampling information includes an overeager load condition indication, the overeager load condition indication indicating that the sample instruction was a store instruction which caused an overeager load to occur, the overeager load condition indication being persistent sample information.

8. An apparatus for sampling instructions executing in a processor comprising:
means for selecting an instruction for sampling;
means for gathering sampling information for the instruction;
means for determining whether the instruction reissues during execution of the instruction;
means for storing reissue sample information if the instruction reissues during execution of the instruction.

9. The apparatus of claim 8 wherein
the reissue sample information is persistent sample information.

10. The apparatus of claim 8 wherein
the sample information includes resettable sample information; and,
the resettable sample information is reset whenever the instruction reissues.

11. The apparatus of claim 8 wherein
the sampling information is stored within an instruction history for the instruction; and
the instruction history includes a reissue bit, the reissue bit indicating whether the instruction reissued.

12. The apparatus of claim 8 wherein
the sampling information includes a data cache replayed condition indication, the data cache replayed condition indicating that a load instruction was replayed at least once due to a data cache condition, the data cache replayed condition indication being persistent sample information.

13. The apparatus of claim 8 wherein
the sampling information includes a memory buffer replayed condition indication, the memory buffer replayed condition indication indicating that a load or store instruction was replayed due to a condition in a memory buffer data cache replayed condition indication, the memory buffer replayed condition indication being persistent sample information.

14. The apparatus of claim 8 wherein
the sampling information includes an overeager load condition indication, the overeager load condition indication indicating that the sample instruction was a store instruction which caused an overeager load to occur, the overeager load condition indication being persistent sample information.

15. A sampling mechanism for sampling an instruction comprising:
sampling logic, the sampling logic selecting an instruction for sampling;
an instruction history register coupled to the sampling logic, the instruction history register storing reissue sample information if the instruction reissues during execution of the instruction.

16. The sampling mechanism of claim 15 wherein
the reissue sample information is persistent sample information.

17. The sampling mechanism of claim 15 wherein
the sample information includes resettable sample information; and,
the resettable sample information is reset whenever the instruction reissues.

18. The sampling mechanism of claim 15 wherein
the sampling information is stored within an instruction history for the instruction; and
the instruction history includes a reissue bit, the reissue bit indicating whether the instruction reissued.

19. The sampling mechanism of claim 15 wherein
the sampling information includes a data cache replayed condition indication, the data cache replayed condition indicating that a load instruction was replayed at least once due to a data cache condition, the data cache replayed condition indication being persistent sample information.

20. The sampling mechanism of claim 15 wherein
the sampling information includes a memory buffer replayed condition indication, the memory buffer replayed condition indication indicating that a load or store instruction was replayed due to a condition in a memory buffer data cache replayed condition indication, the memory buffer replayed condition indication being persistent sample information.

21. The sampling mechanism of claim 15 wherein
the sampling information includes an overeager load condition indication, the overeager load condition indication indicating that the sample instruction was a store instruction which caused an overeager load to occur, the overeager load condition indication being persistent sample information.
